(19) United States
(12) Patent Application Publication
(10) Pub. No.: US 2003/0043022 A1
(43) Pub. Date: Mar. 6, 2003

(54) Messaging system providing message redundancy reduction

(76) Inventors: John M. Burgan, N. Palm Beach, FL (US); Eugene Lopatukhin, Boca Raton, FL (US); Ken S. Lerner, Boca Raton, FL (US)

Correspondence Address: MOTOROLA, INC, INTELLECTUAL PROPERTY SECTION, LAW DEPT, 8000 WEST SUNRISE BLVD, FT LAUDERDAL, FL, 33322, US

(21) Appl. No.: 09/944,615

(22) Filed: Aug. 31, 2001

(51) Int. Cl. G08B 5/22; H04Q 1/30

(52) U.S. Cl. 340/7.21; 340/7.52

(57) ABSTRACT

A two-way messaging system (20) for message redundancy reduction includes a two-way messaging terminal (24) and at least one two-way messaging device (22). The two-way messaging terminal (24) sends a reduced messaging signal to the receiving two-way messaging device (23) in response to receiving from the sending two-way messaging device (21) a redundancy reduced signal (92) including codes representative of one or more message components to be displayed by the receiving two-way messaging device (23) as part of a message. The receiving two-way messaging device (23) responds to the reduced messaging signal by displaying the message with the message components represented by the codes received in the reduced messaging signal.

### BACKGROUND OF THE INVENTION

1. Field of the Invention

This invention generally relates to messaging systems and, more particularly, to two-way messaging systems.

2. Description of the Related Art

Two-way messaging devices, personal communication services (PCS) telephones and the like that enable both receipt and transmission of messages through means of airwave transmissions are well known in the art. An example of such devices is described in U.S. Pat. No. 4,994,797, (hereinafter referred to as the '797 patent) issued Feb. 19, 1991 to Breeden for “Method and System for User Controlled Message Disposition” which is assigned to Motorola, Inc, the assignee of the present invention. As shown in the '797 patent, the system infrastructure includes a computer terminal connected to sources of calls in the form of a data terminal, with a modem and an auto-dialer, and telephones. The input devices are connected into a public branch exchange, or PBX, which selectively connects these input devices to the two-way messaging terminal. The two-way messaging terminal communicates into the PBX by means of a controller and a supervisor that is connected to a microprocessor via a data bus. The microprocessor has a data base memory, and is connected through a data bus to a transmit controller and an encoder which, in turn, is connected to a transmitter via a data bus. Reference should be made to the '797 patent, which is hereby incorporated by reference, if further details relating to the conventional infrastructure of a two-way messaging system are desired.

In a two-way messaging system, the two-way messaging device identifies itself to the infrastructure each time it originates a message using a two-way messaging device identification number, or PIN (personal identification number). This PIN is transmitted to the receiving device to enable the receiving device to identify the originator of the message. In addition, each message is assigned a message identifier code by the system infrastructure for future referencing of the message.

The transmitted message includes several conventional segments or components. First, the message includes a header containing a preamble. The preamble includes the device PIN number to identify the originating two-way messaging device to the system infrastructure and further includes a synchronization portion to enable subsequent synchronized transmission. Following the header, the message further includes the device address of the intended receiving two-way messaging device. Next, the message includes a message data. Frequently, following the message data, the message includes a signature. The signature, for example, can be a device user name, a two-way messaging device number, or a telephone number.

When the transmitted message comprises a reply message, the reply message typically includes a portion of the original received message for which the reply corresponds. Further, data bits frequently are included in the reply message as an indication to the receiving device of the type of message being received.

One disadvantage of conventional messaging systems is the substantial amount of overhead traffic in the messaging signals. Frequently, this overhead traffic includes redundant information. Although an original message signal varies with each message and is unknown to the receiving messaging device, the redundant overhead traffic is relatively fixed and repeated. The redundant information can be in each messaging signal sent by a particular messaging device, or in each messaging signal received by a particular messaging device, or can be repeated by reply to a message originally sent by and stored within a messaging device.

Disadvantageously for the service provider, redundant overhead traffic typically includes non-revenue generating data. For example, in conventional messaging systems, a reply message includes a portion of the original message being responded to for the purpose of assisting the reply recipient in recalling the original message. This repetition of the characters of the original message that is included for clarity and convenience are not considered “sent” characters and there is thus no charge to the user, although there is a related cost to the service provider.

Disadvantageously for the device user, there are other kinds of overhead traffic that are billed to the user. For instance, typically, a device user appends each message sent with a signature such as the sender's name, messaging device address and/or telephone number. Signature characters are typically charged to the user. Similarly, a greeting that is included in the message, such as the first name of the recipient (ie. “Joe-”), is also charged to the user.

What is needed to overcome the above disadvantages of the known messaging systems is an overhead traffic reducing, redundancy-reducing, messaging system.

### BRIEF DESCRIPTION OF THE SEVERAL VIEWS OF THE DRAWINGS

The present invention will be described by way of exemplary embodiments, but not limitations, illustrated in the accompanying drawings in which like references denote similar elements, and in which:

FIG. 1 is a functional block diagram of an embodiment of a two-way messaging system providing message redundancy reduction in accordance with the present invention;

FIG. 2 is a functional block diagram of an embodiment of a two-way messaging device with message redundancy reduction;

FIG. 3 is a functional block diagram of a two-way messaging terminal providing message redundancy reduction;

FIG. 4 is an illustration of a signal format of a signature message that is sent from the two-way messaging device of FIG. 2 to the two-way messaging terminal of FIG. 3;

FIG. 5 is an illustration of a signal format of an attachment signature message sent from the two-way messaging device of FIG. 2 to the two-way messaging terminal of FIG. 3;

FIG. 6 is an illustration of a signal format of a redundancy reduced signal;

FIG. 7 is an illustration of a signal format of a message signal sent to the two-way messaging device of FIG. 2 by the two-way messaging terminal of FIG. 3, in response to receipt of the redundancy reduced signal of FIG. 6;

FIG. 8 is an illustration of a signal format of a second redundancy reduced signal;

FIG. 9 is a format and content of a message displayed on the two-way messaging device of FIG. 2;

FIGS. 10 and 11 form a composite logic flow chart of a computer program stored in a terminal operating software memory of the two-way messaging terminal of FIG. 3 in accordance with the present invention; and

FIGS. 12 and 13 form a composite logic flow chart of a computer program that is stored in an operating software memory of the two-way messaging device of FIG. 2 in accordance with the present invention.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

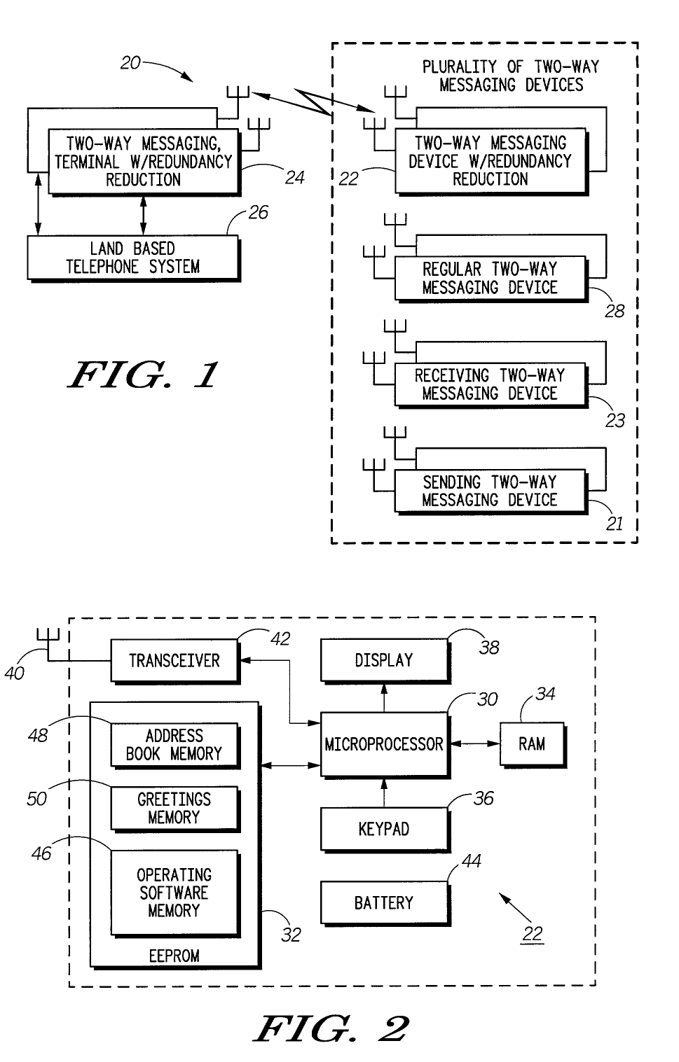

Referring to FIG. 1, an embodiment of a two-way messaging system 20 is illustrated. The two-way messaging system 20 includes a plurality of two-way messaging devices such as a two-way messaging device 22, a sending two-way messaging device 21, and a receiving two-way messaging device 23, and a two-way messaging terminal 24 each providing message redundancy reduction. While this embodiment shall be described with reference to two-way messaging devices such as two-way paging devices, it will be appreciated by one of ordinary skill in the art that the present invention described herein is also equally capable of being used with other like two-way messaging devices, such as PCS telephones, or messaging-telephones, and could also be used with voice messaging products in which the messages are converted to voice, or video two-way messaging devices. Accordingly, in the following description, including the specification and the claims, the term “two-way messaging device refers to any of the devices mentioned above or an equivalent. Similarly, in the following description, including the specification and the claims, the term “two-way messaging terminal” refers to any terminal capable of communicating with a least one of the types of two-way messaging devices in the manner described herein. Further, any reference to a two-way messaging device 22 hereinafter refers to a two-way messaging device providing message redundancy reduction. Similarly, any reference to the two-way messaging terminal 24 refers to a two-way messaging terminal providing message redundancy reduction.

The two-way messaging terminal 24 in accordance with the present invention is connected to a land based telephone system 26. Regular one way paging devices (not shown) and regular two-way messaging devices 28 without message redundancy reduction can also be present in the two-way messaging system 20, and the message redundancy reducing features of the present invention advantageously do not interfere with their use and operation in concert with the two-way messaging terminal 24. The two-way messaging terminal 24 interfaces with the two-way messaging device 22 in accordance with the present invention, and the regular two-way messaging devices 28 via airwave communications. It will be appreciated by one of ordinary skill in the art that the two-way messaging system 20, in accordance with the present invention, may function utilizing airwave communications including any wireless RF channel, for example, a one or two-way pager channel, a mobile cellular channel, or a mobile radio channel. Similarly, it will be appreciated by one of ordinary skill in the art that the two-way messaging system 20 may function utilizing other types of channels such as infrared channels. In the following description, the term “airwave communications” refers to any of the airwave communication systems mentioned above or an equivalent.

Messaging signals preferably are sent from the sending two-way messaging device 21 through the land based telephone system 26 to the two-way messaging terminal 24 that is local to the receiving two-way messaging device 23. The two-way messaging terminal 24 that is local to the receiving two-way messaging device 23 then sends the message via airwave transmission to the receiving two-way messaging device 23. Messages can be sent or received in this manner from the two-way messaging device 22 in accordance with the present invention or the regular two-way messaging devices 28 anywhere in the world where airwave communication is available. Messages can also be sent directly to the two-way messaging device 22 from a telephone or microcomputer or other like message source that is linked by landline connection or mobile link to the land based telephone system 26.

Referring to FIG. 2, the two-way messaging device 22 in accordance with the present invention is illustrated. It will be appreciated by one skilled in the art that the two-way messaging device 22 can be the sending two-way messaging device 21, the receiving two-way messaging device 23, the regular two-way messaging device 28, or an equivalent. The two-way messaging device 22 of FIG. 2 includes an antenna 40, a transceiver 42, an EEPROM 32, a RAM 34, a microprocessor 30, a keypad 36, a display 38 and preferably a battery 44.

To facilitate performance of the two-way messaging device 22 in accordance with the present invention, the microprocessor 30 provides message redundancy reduction capability. The microprocessor 30 utilizes conventional signal processing techniques for processing received messages. Preferably, the microprocessor 30 is similar to the MC68328 micro-controller manufactured by Motorola, Inc. of Schaumburg, Ill. It will be appreciated that other similar processors can be utilized for the microprocessor 30, and that additional processors of the same or alternative type can be added as required to handle the processing requirements of the microprocessor 30.

To perform the necessary functions of the two-way messaging device 22, the microprocessor 30 is coupled to the electrically erasable programmable read-only memory (EEPROM) 32 and the random access memory (RAM) 34. The RAM 34 stores message data including a message identifier that is assigned to each message.

Preferably, the keypad 36 is coupled to the microprocessor 30 for manual input to the microprocessor 30. Further, preferably, the display 38 is coupled to the microprocessor 30. The display 38 receives signals from the microprocessor 30 to display messages or other control and programming information such a visual notification of the receipt and storage of a message. The display 38 can be, for example, a full or partial starburst liquid crystal display utilized to display text. It will be appreciated that other similar displays such as dot matrix displays can be utilized for the display 38.

The antenna 40 intercepts transmitted signals from the two-way messaging system 20. The antenna 40 is coupled to the transceiver 42, which employs conventional demodulation techniques for receiving the message signals transmitted by the two-way messaging system 20. When a message is signal is received by the transceiver 42, the transceiver 42, coupled to the microprocessor 30, sends the demodulated signal to the microprocessor 30 for further processing. For example, the microprocessor 30 decodes an address in the demodulated data of the received message, compares the decoded address with one or more addresses stored in the EEPROM 32, and when a match is detected, proceeds to process the remaining portion of the received message signal. The transceiver 42 further transmits message signals via the antenna 40 to the two-way messaging system 20. The transceiver 42 is coupled to the microprocessor 30 and is responsive to commands from the microprocessor 30. When the transceiver 42 receives a command from the microprocessor 30, the transceiver 42 sends a message signal via the antenna 40 to the two-way messaging system 20.

Preferably, the two-way messaging device 22 includes the battery 44, which can be rechargeable, for providing portable power for all of the other components of the two-way messaging device 22 providing message redundancy reduction.

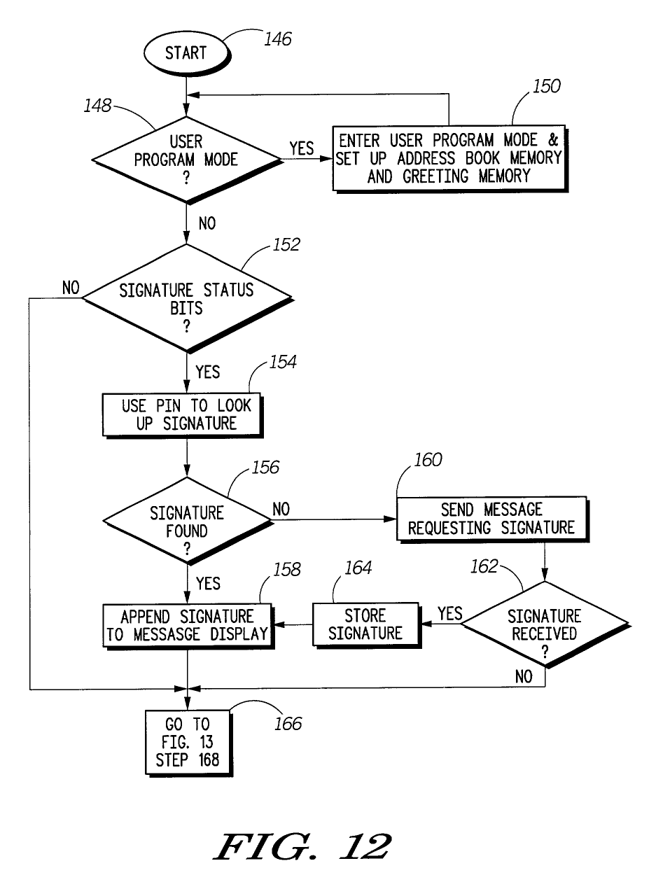

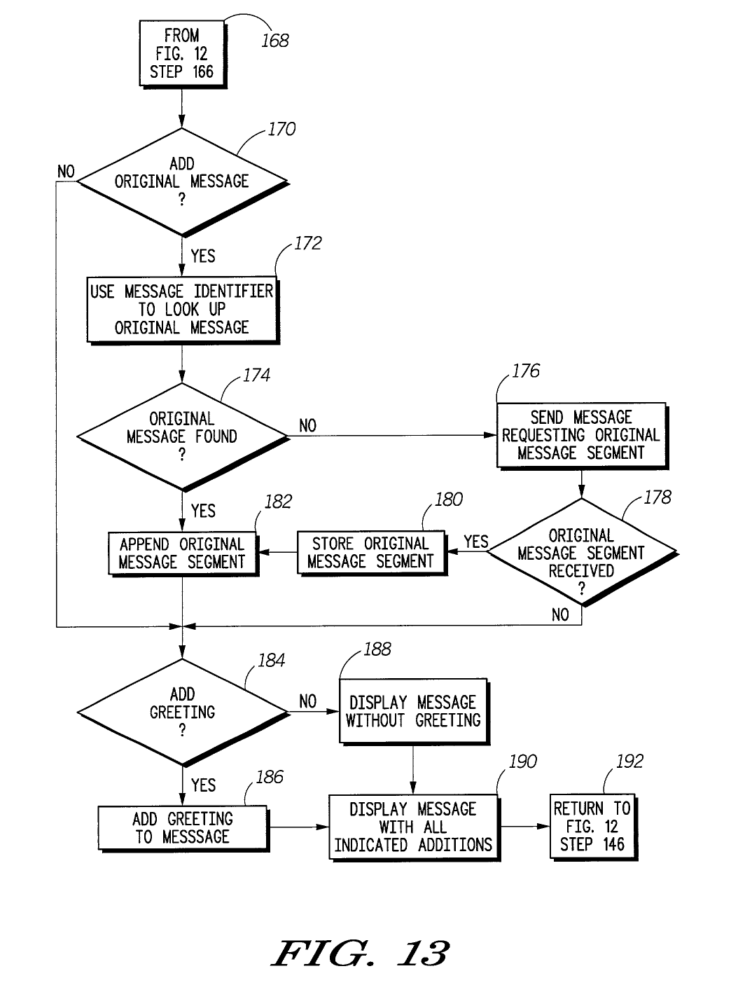

The EEPROM 32 of FIG. 2 includes an operating software memory 46 in which a computer program that operates in accordance with the logic flow chart of FIGS. 12 and 13 is stored and controls the operating functions of the microprocessor 30. The EEPROM 32 also includes an address book memory 48 for storing signatures and associated addresses or PINs, or two-way messaging device identification numbers, preferably in a lookup table. The EEPROM 32 also includes a greetings memory 50 for storing standard greeting for the user of the two-way messaging device (e.g. “Joe-”).

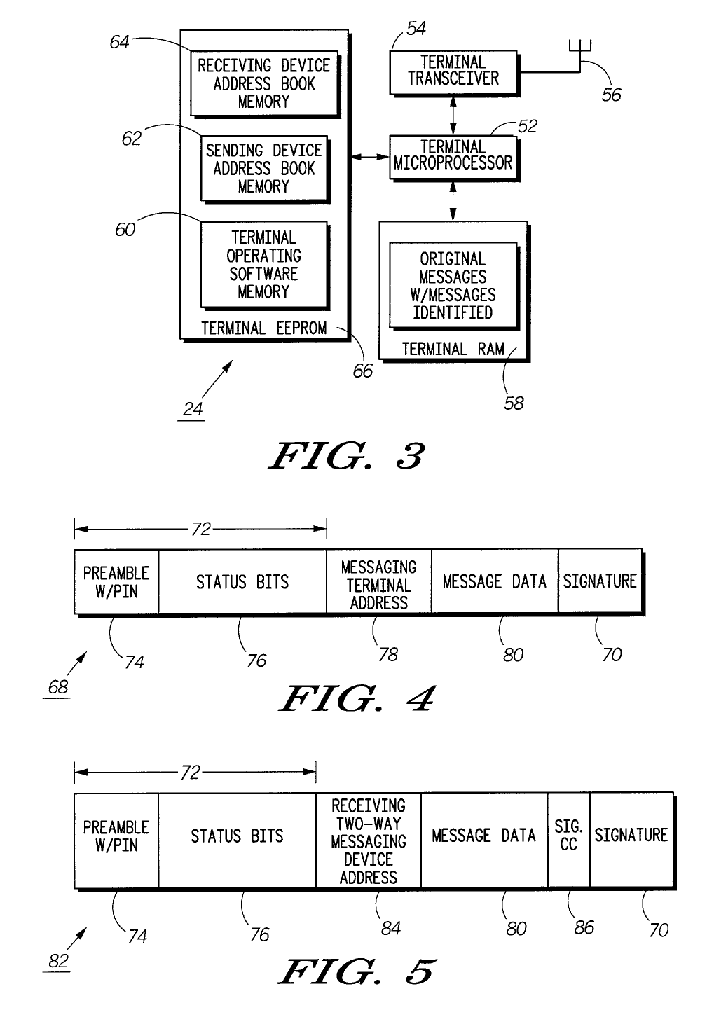

Referring to FIG. 3, an embodiment of the two-way messaging terminal 24 for use within the two-way messaging system 20 of FIG. 1 is illustrated. The two-way messaging terminal 24 includes a terminal microprocessor 52, a terminal transceiver 54, a terminal antenna 56, a terminal RAM 58, and a terminal EEPROM 66.

The terminal antenna 56 intercepts transmitted signals from the two-way messaging system 20. The terminal antenna 56 is coupled to the terminal transceiver 54, which employs conventional demodulation techniques for receiving the message signals transmitted by the two-way messaging system 20. When a message signal is received by the terminal transceiver 54, the terminal transceiver 54, coupled to the terminal microprocessor 52, sends the demodulated signal to the terminal microprocessor 52 for further processing. For example, the terminal microprocessor 52 decodes an address in the demodulated data of the received message, compares the decoded address with one or more addresses stored in the terminal EEPROM 66, and when a match is detected, proceeds to process the remaining portion of the received message signal. The terminal transceiver 54 further transmits message signals via the terminal antenna 56 to the two-way messaging system 20. The terminal transceiver 54 is coupled to the terminal microprocessor 52 and is responsive to commands from the terminal microprocessor 52. When the terminal transceiver 54 receives a command from the terminal microprocessor 52, the terminal transceiver 54 sends a message signal via the terminal antenna 56 to the two-way messaging system 20.

The terminal microprocessor 52 utilizes conventional signal processing techniques for processing received message signals. Preferably, the terminal microprocessor 52 is similar to the MC68328 micro-controller manufactured by Motorola, Inc. of Schaumburg, Ill. It will be appreciated that other similar processors can be utilized for the terminal microprocessor 52, and that additional processors of the same or alternative type can be added as required to handle the processing requirements of the terminal microprocessor 52.

To perform the necessary functions of the two-way messaging terminal 24, the terminal microprocessor 52 is coupled to the terminal EEPROM 66 and the terminal RAM 58. Messages are stored in the terminal RAM 58. The message identifier assigned to each message passed through the two-way messaging terminal 24 is also stored in the terminal RAM 58.

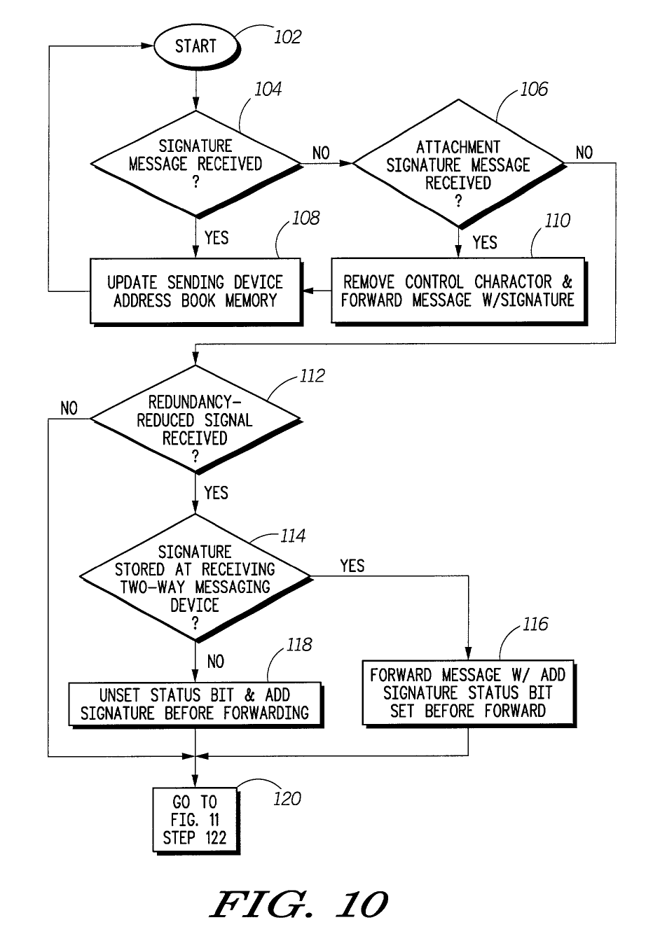

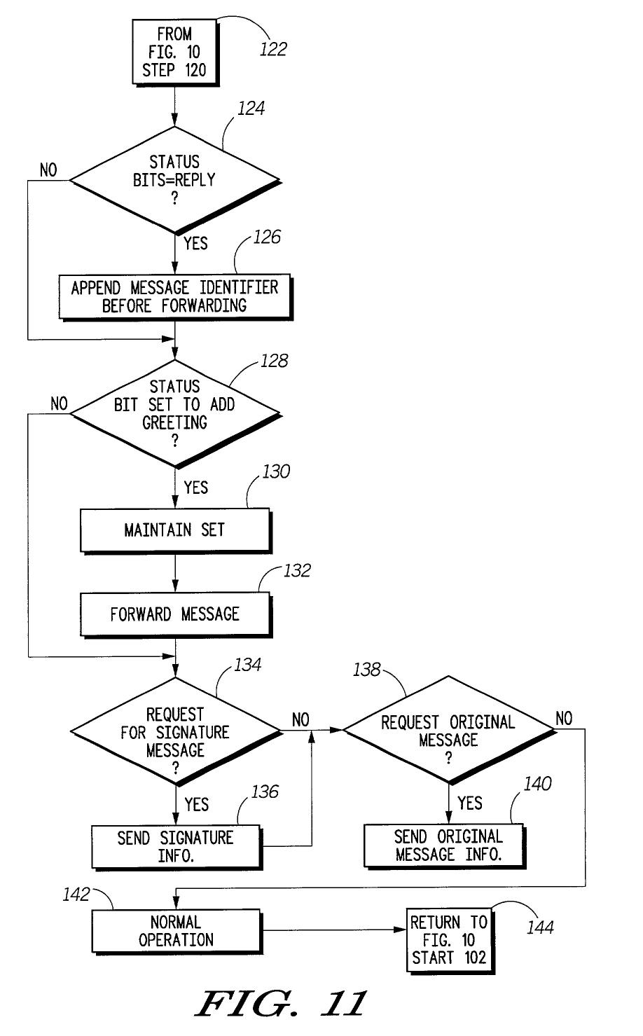

Operating software providing message redundancy reduction is stored in a terminal operating software memory 60 of the terminal EEPROM 66 that controls the terminal microprocessor 52 in accordance with the logic flow chart of FIGS. 10 and 11. The terminal EEPROM 66 also includes a sending device address book memory 62 for storing the two-way messaging device identification numbers and the associated signatures of the sending two-way messaging devices 21 that are sending redundancy reduced messages with respect to the signature, preferably in a lookup table. The terminal EEPROM 66 further includes a receiving device address book memory 64 for storing the PIN numbers of the receiving two-way messaging devices 23 that have stored signatures of the sending two-way messaging devices 21.

In accordance with the present invention, in one embodiment, the two-way messaging terminal 24 sends non-reduced messaging signals to receiving two-way messaging devices 23 in response to receipt of a message signal from a sending two-way messaging device 21 with codes representative of information to be added to display of the message on the display 38 of the receiving two-way messaging device 23. The receiving two-way messaging device 23 in this scenario displays the non-reduced message without alteration on the display 38. The codes are preferably status bits contained within a header of the message signal.

Alternatively, in the case of receiving two-way messaging devices 23 that already have stored the information represented by the status bits, or other codes, the redundancy reduced messaging signals with codes representative of information to be displayed at the receiving two-way messaging device 23 as part of a message are forwarded to the receiving two-way messaging device 23 without alteration, including the codes. The receiving two-way messaging device 23 responds to the codes forwarded by the two-way messaging terminal 24 in the message signal by displaying messages with the information represented by the codes received along with the message data on the display 38.

Preferably, the two-way messaging terminal 24 has redundancy reducing capabilities, and the two-way messaging device 22 is capable of either producing messages in response to the non-reduced signals without alteration or to respond to the codes in a redundancy reduced message to add the information represented by the codes to the message as displayed on the display 38.

The codes can represent commands to insert at least one of the types of message components such as: (a) senders signature, (b) original message segment to which a reply message is a response, and (c) a personalized greeting. Each redundancy reduced messaging signal can have any one, any two or all three of the codes. One skilled in the art will appreciate that the codes can represent commands to insert any of the types of message components described above or an equivalent.

Unlike message compression devices or other devices that employ message short hand techniques (“canned messages”), the receiving two-way message device 23 responds to the codes as commands to insert information the receiving two-way message device 23 already has in its possession and which is not necessarily known to the sending two-way messaging device 21 or the two-way messaging terminal 24, and also which is not necessarily the same in each received message.

The receiving two-way messaging device 23 has stored in the appropriate section of the EEPROM 32 and, in response to receipt of the appropriate codes, produces from storage for display on the display 38 the message components such as: (a) the senders signature, (b) a segment of an original message to which a reply message is a response, and (c) a personalized greeting, respectively in response to receipt of a message with the corresponding codes commanding the display of such message components.

In the case of a command to add a segment of an original message, the two-way messaging terminal 24 responds to a code from the sending two-way messaging device 21 by adding a message identifier of an original message to which the reply is a response. The receiving two-way messaging device 23 responds to the code and to the message identifier by adding a segment of the original message to a message display of the reply message.

In the case of the two-way messaging device 22 lacking the information corresponding to the codes in the redundancy reduced message signal corresponding to commands to insert the signature or a segment of the original message, the receiving two-way messaging device 23 automatically transmits a special message to the two-way messaging terminal 24 requesting refreshment of its address book memory 48 or the section of RAM 34. This information is then transmitted back to the two-way messaging device 22 by the two-way messaging terminal 24.

FIG. 4 is one embodiment of a signal format for informing the two-way messaging terminal 24 of the signature that is to be added to a message when the appropriate code is sent by the sending two-way messaging device 21. Specifically, FIG. 4 is an illustration of the signal format of a signature message 68 that is sent from the sending two-way messaging device 21 of FIG. 2 to the two-way messaging terminal 24 of FIG. 3 to provide the two-way messaging terminal 24 with a signature 70 of the sending two-way messaging device 21 for storage in the sending device address book memory 62 of the two-way messaging terminal 24. For example, the sending two-way messaging device 21 can send the signature message 68 of FIG. 4 whenever the signature 70 is initially set or is changed in the sending two-way messaging device 21. The signal format for the signature message 68 includes a header 72, wherein the header includes a preamble 74 and one or more status bits 76. The status bits 76 can be special characters or bit settings indicating that the signature 70 follows. The signature message 68 further includes a messaging terminal address 78, a message data 80, and the signature 70. Preferably, the messaging terminal address 78 is an address indicating the signature message 68 is intended for one or more two-way messaging terminals such as the two-way messaging terminal 24. It will be appreciated by one of ordinary skill in the art that the messaging terminal address 78 can be any of the addresses mentioned or an equivalent. Typically, the message data 80 portion of the signature message 68 is empty since the key purpose of the signature message 68 is to send the signature 70. However, one skilled in the art will appreciate that the message data 80 of the signature message 68 can include information other than the signature 70 for use by the two-way messaging terminal 24. The two-way messaging terminal 24 responds to receipt of the signature message 68 by storing the signature 70 contained in the signal in the sending device address book memory 62, FIG. 3, along with the associated PIN number that is contained in the header 72.

FIG. 5 is another embodiment of a signal format for informing the two-way messaging terminal 24 of the signature 70 that is to be added to a message when the appropriate code is sent by the sending two-way messaging device 21. Specifically, FIG. 5 is an illustration of the signal format of an attachment signature message 82 that is sent from the sending two-way messaging device 21 of FIG. 2 to the two-way messaging terminal 24 of FIG. 3 to provide the two-way messaging terminal 24 with the signature 70 of the sending two-way messaging device 21 for storage in the sending device address book memory 62 of the two-way messaging terminal 24. For example, the attachment signature message 82 can be the next regular message sent by the sending two-way messaging device 21 after the signature 70 of the sending two-way messaging device 21 has been initially set or changed. The signal format for the attachment signature message 82 includes the header 72, wherein the header includes the preamble 74 and one or more status bits 76. The status bits 76 can be special characters or bit settings indicating that a message data and the signature 70 follow. The attachment signature message 82 further includes a receiving two-way messaging device address 84, the message data 80, and the signature 70. Preferably, the receiving two-way messaging device address 84 is an address indicating the message data 80 is intended for one or more two-way messaging devices such as the receiving two-way messaging device 23. It will be appreciated by one of ordinary skill in the art that the receiving two-way messaging device address 84 can be any of the addresses mentioned or an equivalent. Preferably, the attachment signature message 82 further includes a signature control character 86. The signature control character 86, abbreviated “SIG. CC” in FIG. 5, marks where the message data 80 ends and the signature 70 for storage in the sending device address book memory 62 begins. Upon receipt of the attachment signature message 82, the two-way messaging terminal 24 updates the sending device address book memory 62 with the signature 70 along with the associated PIN number that is contained in the header 72; and also processes the message data 80 to forward the message data 80 to the receiving two-way messaging device 23.

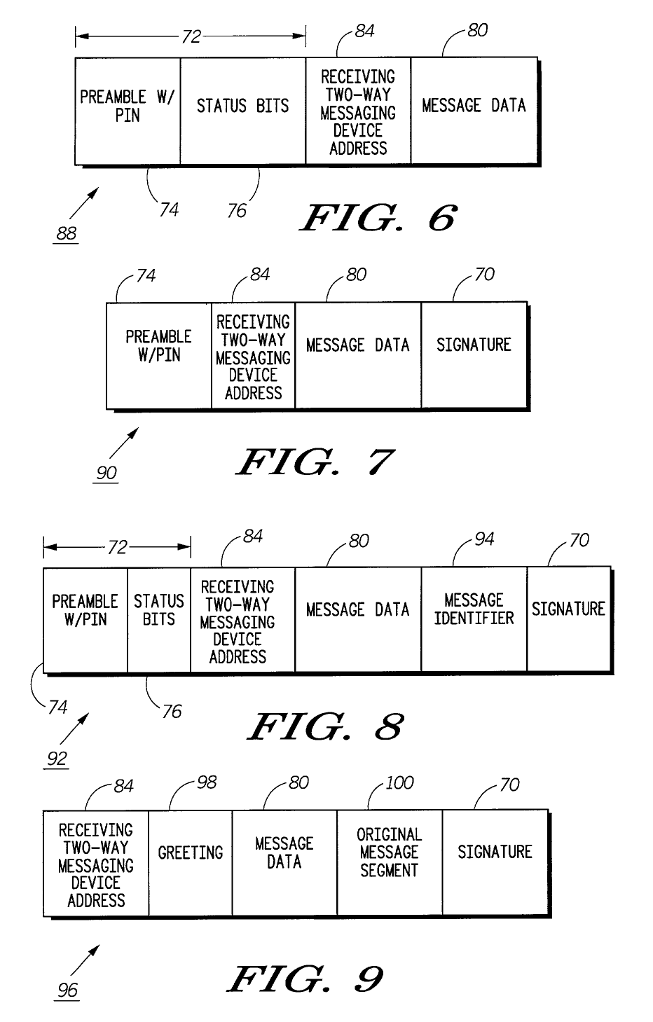

FIG. 6 is an illustration of the signal format of a redundancy reduced signal 88 that alternatively is created at the two-way messaging terminal 24 or is created by the sending two-way messaging device 21 and forwarded by the two-way messaging terminal 24 without alteration to the receiving two-way messaging device 23. The redundancy reduced signal 88 of FIG. 6 includes the header 72, wherein the header 72 includes the preamble 74 and one or more status bits 76. The preamble 74 of the header 72 preferably includes the PIN associated with the sending two-way messaging device 21 which originated the redundancy reduced signal 88. The status bits 76 can be special characters or bit settings indicating that redundancy elimination of either or both of the signature 70 and a message greeting have been implemented in conjunction with the message data 80. The status bits 76 further represent a command to add the signature 70 or other message addendum to the message data 80. The status bits 76, for example, can be the codes representing commands to insert at least one message component such as: (a) senders signature, (b) original message segment to which a reply message is a response, and (c) a personalized greeting. Each redundancy reduced messaging signal can have any one, any two or all three of the codes. One skilled in the art will appreciate that the status bits 76 can represent commands to insert any of the types of message components described above or an equivalent. The redundancy reduced signal 88 further includes the receiving two-way messaging device address 84 and the message data 80. Preferably, the receiving two-way messaging device address 84 is an address indicating the message data 80 is intended for one or more two-way messaging devices such as the receiving two-way messaging device 23. It will be appreciated by one of ordinary skill in the art that the receiving two-way messaging device address 84 can be any of the addresses mentioned or an equivalent.

When the redundancy reduced signal 88 with a signal format of the form shown in FIG. 6 that lacks the signature 70 but contains the status bits 76 in the header 72 representing a command to add the signature 70 is received by the two-way messaging terminal 24 from the sending two-way messaging device 21, the two-way messaging terminal 24 responds by looking for the signature 70. The two-way messaging terminal 24 checks in the receiving device address book memory 64 to determine whether the receiving two-way messaging device 23, as identified by the receiving two-way messaging device address 84 has the signature 70 of the sending two-way messaging device 21 stored in the address book memory 48, FIG. 2, of the receiving two-way messaging device 23. When it is determined that the signature 70 of the sending two-way messaging device 21 is not stored at the receiving two-way messaging device 23, then the two-way messaging terminal 24 unsets the status bits 76 indicating that a signature 70 needs to be added and, itself, adds the signature 70 to the signal before forwarding it to the receiving two-way messaging device 23 in the signal format shown in FIG. 7.

FIG. 7 is an illustration of the signal format of a message signal 90 sent to the receiving two-way messaging device 23 by the two-way messaging terminal 24, in the case of receipt of the redundancy reduced signal 88 having the format shown in FIG. 6 and with the status bits 76 indicating that the signature 70 should be added, which is used when the receiving two-way messaging device 23 is not message redundancy reduction enabled, itself, to produce the signature 70 directly in response to the redundancy reduced signal 88. The message signal 90 of FIG. 7 includes the preamble 74, wherein the preamble 74 preferably includes the PIN associated with the sending two-way messaging device 21 which originated the redundancy reduced signal 88. The message signal 90 further includes the receiving two-way messaging device address 84, the message data 80, and the signature 70. Preferably, the receiving two-way messaging device address 84 is an address indicating the message data 80 is intended for one or more two-way messaging devices such as the receiving two-way messaging device 23. It will be appreciated by one of ordinary skill in the art that the receiving two-way messaging device address 84 can be any of the addresses mentioned or an equivalent.

Alternatively, when the two-way messaging terminal 24 determines that the receiving two-way messaging device 23 already has stored the signature 70 of the sending two-way messaging device 21, then the status bits 76 indicating addition of the signature 70 remains set, and the signal is forwarded without signature, in the format of the redundancy reduced signal 88 shown in FIG. 6, for addition to the displayed message by the receiving two-way messaging device 23. Similarly, the status bits 76 can indicate not only the addition of the signature 70 but also the addition of a greeting stored in the greetings memory 50 of the receiving two-way messaging device 23. When the receiving two-way messaging device 23 receives such a signal with the status bits 76 set to add the greeting, then the greeting stored in the greetings memory 50 of the EEPROM 32 is automatically added to the front of the message data 80 for display on the display 38, FIG. 2.

FIG. 8 is an illustration of the signal format of a second redundancy reduced signal 92 that alternatively is created at the two-way messaging terminal 24 or is created by the sending two-way messaging device 21 and forwarded by the two-way messaging terminal 24 without alteration to the receiving two-way messaging device 23, and in which the status bits 76 in the header 72 indicate redundancy elimination of transmission of an original message segment to which the current message is a reply, as identified by a message identifier 94 and appended to the message data 80. The second redundancy reduced signal 92 of FIG. 8 includes the header 72, wherein the header 72 includes the preamble 74 and one or more status bits 76. The preamble 74 of the header 72 preferably includes the PIN associated with the sending two-way messaging device 21 which originated the second redundancy reduced signal 92. The status bits 76 can be special characters or bit settings indicating redundancy elimination of transmission of an original message segment to which the current message is a reply have been implemented in conjunction with the message data 80. The status bits 76 further represent a command to add the message identifier 94, the signature 70, and/or other message addendum to the message data 80. The redundancy reduced signal 88 further includes the receiving two-way messaging device address 84 and the message data 80. Preferably, the receiving two-way messaging device address 84 is an address indicating the message data 80 is intended for one or more two-way messaging devices such as the receiving two-way messaging device 23. It will be appreciated by one of ordinary skill in the art that the receiving two-way messaging device address 84 can be any of the addresses mentioned or an equivalent.

When the two-way messaging terminal 24 receiving a reply message in a redundancy reduced signal 88 of the format of FIG. 6 with the status bits 76 indicating addition of a segment of the original message to which the reply message is a response, and then the two-way messaging terminal 24 appends the message identifier 94 of the original message. This message identifier 94 is stored with the original message in the terminal RAM 58. After the message identifier 94 has been added then the second redundancy reduced signal 92 is sent with a signal format shown in FIG. 8.

When the receiving two-way messaging device 23 receives the second redundancy reduced signal 92 with the status bits 76 set for adding the original message segment, it looks for, reads and uses the message identifier 94 to locate the original message segment stored in the RAM 34 and adds it to the end of the reply message when displayed on the display 38, FIG. 2.

FIG. 9 is the format and content of a message 96 displayed on the display 38 of the receiving two-way messaging device 23 in response to an original message with status bits 76 for redundancy elimination of the original message segment, greeting and signature. As illustrated, the message 96 that is displayed when all three status bits have been set includes a greeting 98, the message data 80, an original message segment 100 and the signature 70 that has been added either at the two-way messaging terminal 24 and sent to the two-way messaging device 22 or which is added by the receiving two-way messaging device 23, itself.

FIGS. 10 and 11 form a composite logic flow chart of a computer program stored in the terminal operating software memory 60 of the two-way messaging terminal 24 of FIG. 3 to control the two-way messaging terminal 24 in accordance with the present invention. After the start 102, a determination is made in step 104 whether the signature message 68 has been received having the signal format of FIG. 4. When the signature message 68 has not been received, the process continues to step 106. In step 106, a determination is made whether the attachment signature message 82 has been received having the signal format shown in FIG. 5.

Returning to step 104, when the signature message 68 has been received, the process continues to step 108. In step 108, the sending device address book memory 62 is updated. The sending device address book memory 62 is updated with the two-way messaging device identification number and the associated signature 70, which were both sent with the signature message 68. When a previous signature is stored in associated with the received PIN, then it is erased and overwritten with the new signature. The signature 70 can contain several components such as the name of the user, the two-way messaging device email address and the telephone number of the user. The process then returns to step 102, start.

Referring again to step 106, when the attachment signature message 82 has been received, the two-way messaging terminal 24 automatically removes the signature control character 86 and forwards the message with the signature 70 attached. The process then moves to Step 108, wherein the sending device address book memory 62 is updated with the two-way messaging device identification number and the associated signature 70, which were both sent with the signature message 68. When a previous signature is stored in associated with the received PIN, then it is erased and overwritten with the new signature. The process then returns to step 102, start.

The advantage of this approach is that it eliminates the cost of sending the signature message 68 for the sole purpose of updating the signature 70, and further eliminates the need for recognizing the signature message 68. Nonetheless, some users wish to change their signature immediately and not wait until the next message. Preferably, as indicated by the logic flow chart both methods are made available, but it must be recognized that only one is required in order for the two-way messaging system 20 to function as intended.

When in step 106, a determination is made that the attachment signature message 82 has not been received, then the program moves to step 112 to determine whether the redundancy reduced signal 88 has been received with a status bits 76 set commanding addition of a signature 70 either by the two-way messaging terminal 24 or by the receiving two-way messaging device 23. When the redundancy reduced signal 88 has not been received, the program moves to Step 120. When a message having the redundancy reducing signal 88 format of FIG. 6 has been received with one of the status bits 76 set to indicate addition of the sender's signature, the process moves to step 114. In step 114 it is determined whether the signature associated with the PIN of the sending two-way messaging device 21 has been stored at the receiving two-way messaging device 23 in the address book memory 48, FIG. 2. When the signature has been stored at the receiving two-way messaging device 23, then in step 116, the message is sent to the receiving two-way messaging device 23 in a redundancy reduced format of FIG. 6 with the status bits 76 still set for addition of the signature 70. When the signature has not been stored at the receiving two-way messaging device 23, then in step 118, the two-way messaging terminal 24 unsets the status bit, looks up the signature based upon the PIN of the sending two-way messaging device 21 that appears in the header 72, and appends the signature to the message signal before forwarding to the receiving two-way messaging device 23. The program then moves on to Step 120.

The program in step 120 then moves to step 122 of FIG. 11. Next, at step 124, the program determines whether the received message signal includes the status bits 76 in the header 72 indicate redundancy elimination of transmission of an original message segment to which the current message is a reply. When the received message signal includes status bits indicating a reply including redundancy elimination of transmission of an original message segment, the process moves to step 126 in which the two-way messaging terminal 24 looks up the message identifier 94 stored in the terminal RAM 58 and appends it to the message data 80 before it is forwarded to the receiving two-way messaging device 23. The format of the forwarded signal is the second redundancy reduced signal 92 corresponding to that shown in FIG. 8. When in step 124 the status bits 76 for a reply are not set, or after the message identifier 94 is added in step 126, the program proceeds to step 128.

At step 128, a decision is made as to whether the status bits 76 include a command to add the greeting 98 is included in the received message signal. When the status bits 76 for adding the greeting 98 is set, then in step 130 the status bits 76 are maintained in a set condition, and the redundancy reduced message signal is then forwarded to the receiving two-way messaging device 23 in step 132. One, two all three of the status bits 76 can be set or none of the status bits 76 can be set. When all three are set, then format of the message that when finally displayed at the receiving two-way messaging device 23 is the message 96 as shown in FIG. 9.

In the message 96 shown in FIG. 9, the message 96 has all three components that have been added in response to set status bits 76. The message 96 includes the greeting 98 that is inserted by the receiving two-way messaging device 23 from the greetings memory 50. The original message segment 100 identified by the message identifier 94 is taken from the RAM 34 of the receiving two-way messaging device 23 and appended to the message data 80. The signature 70 that is identified by the PIN number of the received message signal and taken from the address book memory 48 of the EEPROM 32 is added to the end of the message 96. Alternatively, the actual signature is sent by the two-way messaging terminal 24 from the sending device address book memory 62 in response to receipt of the second redundancy reduced messaging signal 92.

After the message 96 is forwarded in step 132, and when no greeting is requested in step 128, next in step 134, the program monitors for receipt of a request for signature message from the receiving two-way messaging device 23 requesting that the signature 70 be sent in case the sending two-way messaging device 21 signature 70 cannot be found in storage at the two-way messaging device 22. When the two-way messaging terminal 24 receives the request for signature message, then in step 136, the signature 70 is pulled from the sending device address book memory 62 and sent to the requesting two-way messaging device 23 as the signature message 68 from the two-way messaging terminal 24.

Next, and when no request for signature message is received in step 134, in step 138 a determination is made as to whether a message has been received from the receiving two-way messaging device 23 requesting the original message associated with the reply received by the receiving two-way messaging device 23. When the two-way messaging terminal 24 receives such a message, then in step 140, the original message segment 100 is retrieved from the terminal RAM 58 and sent to the requesting two-way messaging device 22.

After this information is sent, or when there is no request, the program returns to normal operation in step 142 in which it redundantly responds to conventional messaging signals. Likewise, a messaging signal of the invention that is received with none of the status bits 76 set will be treated the same as in normal operation with no message redundancy reduction action being taken. Then, the program in step 144 returns to start 102 of FIG. 10.

FIGS. 12 and 13 form a composite logic flow chart of a computer program that is stored in the operating software memory 46 of the two-way messaging device 22 of FIG. 2 to control the two-way messaging device 22 in accordance with the present invention. Referring to the logic flow chart, after start 146, in step 148 a determination is made as to whether the user has selected the user program mode. When the user program mode is entered, then in step 150 the user can setup or amend the address book memory 48 and setup or amend the greetings memory 50. The user can setup or amend the address book memory 48 or the greetings memory 50 using the keypad 36. Similarly, the user can choose from a menu of pre-stored choices, or can program the address book memory 48 or the greetings memory 50 using a programming device. It will be appreciated by one skilled in the art that the user can setup or amend the user can setup or amend the address book memory 48 or the greetings memory 50 using one of the methods mentioned above or an equivalent.

When the user program mode is not entered in step 148, then next in step 152 a decision is made whether a message signal has been received with a signature status bit set such as the message signal 90 of FIG. 7. When the message signal 90 is received, then next in step 154 the PIN contained in the preamble 74 of the message signal 90 is used to look up the signature 70 in the address book memory 48. Next, in step 156, when the signature 70 is found, then in step 158 the signature 70 is appended to the message 96 displayed on the display 38 as shown in FIG. 9.

When the signature 70 is not found in step 156, then in step 160, a message is sent to the two-way messaging terminal 24 requesting the signature 70. Next, in step 162, the program awaits receipt of the signature message 68 with the signature information. When the signature 70 is received, in step 164 the signature 70 is stored in the address book memory 48. The program then proceeds to step 158, and the signature 70 is appended to the message 96 for display on the display 38. When the signature message 68 is not received, or upon completion of step 158, the program next proceeds to step 166.

Referring to FIG. 13, from step 168, the program proceeds to step 170 at which it is determined when the received message signal has a status bit set commanding the appending of a segment of an original message to which the received reply message is a response such as the second redundancy reduced signal 92 of FIG. 8. When this bit is set, then in step 172, the message identifier 94 of the second redundancy reduced signal 92 is used to look up the original message. In step 174, when the original message is not found, for example because of being purged from the memory or for any other reason, then in step 176, a message is sent to the two-way messaging terminal 24 requesting the original message segment 100 be sent to the receiving two-way messaging device 23. In step 178, the program checks for receipt of the original message segment 100. When the original message is received in step 178, then next in step 180, the received original message segment is stored. Next, in Step 182, the original message segment 100 is appended to the message data 80 before displaying on the display 38. Likewise, when the original message is found in step 174, then the program proceeds to step 182 to append the original message segment 100 directly from its own memory.

After the original message segment 100 is appended in step 182, or when in step 170, the status bit representative of the command to add the original message segment is not set or when the original message is not received in step 178, the program proceeds to step 184. In step 184, a determination is made whether the received message signal has a status bit directing the receiving two-way messaging device 23 to add a greeting 98 to the message data 80. When this status bit is set, then in step 186 the greeting 98 is added to the front of the displayed message. The program then continues to step 190. When no greeting is required in step 184, then in step 188, the message is displayed without the addition of a greeting. Next, in step 190, the entire message is displayed with all the additions indicated by the three different status bits 76 to the extent that information was made available by either the two-way messaging terminal 24 or the two-way messaging device 22, itself. Next, in step 192, the program returns to start 146, FIG. 12.

While a particular embodiment has been disclosed in detail, the scope of the invention is not limited to such detail but rather is defined by the appended claims. For instance, although only three types of redundancy have been identified for reduction by the present invention, it should be appreciated that any other type of information in a message, that is already available at the receiving end of a transmission can be redundancy reduced in accordance with the teaching of the present invention. Also, although status bits that are selectively set are the codes that are used in the disclosed embodiment and the codes are contained within the header for conveying commands, it should be appreciated that other codes could also be employed successfully to achieve the redundancy reducing object of the present invention.

Although the invention has been described in terms of preferred embodiments, it will be obvious to those skilled in the art that various alterations and modifications can be made without departing from the invention. Accordingly, it is intended that all such alterations and modifications be considered as within the spirit and scope of the invention as defined by the appended claims.

What is claimed is:

1. A two-way messaging system for message redundancy reduction, comprising:
a two-way messaging terminal for:
sending a non-reduced messaging signal to a receiving two-way messaging device in response to receiving from a sending two-way messaging device a redundancy reduced signal including codes representative of one or message components to be displayed by the receiving two-way messaging device as part of a message, and thereafter
sending a reduced messaging signal to the receiving two-way messaging device in response to receiving from the sending two-way messaging device a second redundancy reduced signal including codes representative of one or more message components to be displayed by the receiving two-way messaging device as part of a second message; and
the receiving two-way messaging device for:
responding to the non-reduced messaging signal by displaying the message contained within the non-reduced messaging signal, and
responding to the reduced messaging signal by displaying the second message with the message components represented by the codes received in the reduced messaging signal.

2. The two-way messaging system as recited in claim 1 wherein the message component is a signature of the sending two-way messaging device.

3. The two-way messaging system as recited in claim 1 wherein the message component is a greeting of the sending two-way messaging device.

4. The two-way messaging system as recited in claim 1 wherein the message component is an original message segment.

5. The two-way messaging system as recited in claim 1 wherein the receiving two-way messaging device comprises:
a memory for storing the message components;
a microprocessor coupled to the memory for retrieving the stored message components; and
a display coupled to the microprocessor for displaying the message including the message components in response from a command from the microprocessor.

6. The two-way messaging system of claim 5 further comprising:
a transceiver, coupled to the microprocessor and responsive to commands from the microprocessor, for transmitting a request message to the two-way messaging terminal requesting refreshment of the memory of the receiving two-way messaging device when one or more of the message components is not contained in the memory.

7. The two-way messaging system of claim 1 wherein the second redundancy reduced signal sent from the two-way messaging terminal includes a message identifier, and further wherein the receiving two-way messaging device responds to the message identifier by adding an original message segment to the message display.

8. A two-way messaging system for message redundancy reduction, comprising:
a sending two-way messaging device, wherein the sending two-way messaging device transmits a signature message comprising:
a header including a preamble having a sending device identification,
a messaging terminal address for identifying a two-way messaging terminal to which the signature message is intended for, and
a signature; and
the two-way messaging terminal, wherein the two-way messaging terminal comprises:
a terminal transceiver for receiving the signature message from the sending two-way messaging device,
a terminal memory for storing the signature and associated sending device identification in response to receiving the signature message.

9. The two-way messaging system for message redundancy reduction as recited in claim 8 further comprising:
a receiving two-way messaging device,
wherein the sending two-way messaging device sends a redundancy reduced signal to the two-way messaging terminal, wherein the redundancy reduced signal comprises:
a preamble including the sending device identification,
one or more status bits for indicating redundancy reduction,
a receiving two-way messaging device address, and
a message data,
and further wherein the two-way messaging terminal in response to receiving the redundancy reduced signal retrieves the signature from memory using the sending device identification and appends the signature to the message data, and further wherein the two-way messaging terminal transmits the message data including the signature to the receiving two-way messaging device.

10. The two-way messaging system for message redundancy reduction as recited in claim 8 further comprising:
a receiving two-way messaging device having a memory and a display,
wherein the sending two-way messaging device sends a redundancy reduced signal to the receiving two-way messaging device, wherein the redundancy reduced signal comprises:
a preamble including the sending device identification,
one or more status bits for indicating redundancy reduction,
a receiving two-way messaging device address, and
a message data,
and further wherein the receiving two-way messaging device in response to receiving the redundancy reduced signal retrieves the signature from the memory using the sending device identification, and further wherein the receiving two-way messaging device display the message data and the signature on the display.

11. The two-way messaging system for message redundancy reduction as recited in claim 10 wherein the status bits of the redundancy reduced signal further includes a status bit indicating the addition of a greeting, and further wherein the receiving two-way messaging device in response to receiving the redundancy reduced signal retrieves the greeting from the memory, and further wherein the receiving two-way messaging device displays the greeting along with the message data and the signature on the display.

12. The two-way messaging system for message redundancy reduction as recited in claim 10 wherein the status bits of the redundancy reduced signal further includes a status bit indicating the addition of an original message segment, and further wherein the receiving two-way messaging device in response to receiving the redundancy reduced signal retrieves the original message segment from the memory, and further wherein the receiving two-way messaging device displays the original message segment along with the message data and the signature on the display.
